(19) United States
(12) Patent Application Publication
(10) Pub. No.: US 2010/0243592 A1
(43) Pub. Date: Sep. 30, 2010

(54) CEILING MOVABLE TYPE DISUSED CAR SCRAPPING SYSTEM

(76) Inventor: Jeong-Soo Ko, Daejeon (KR)

Correspondence Address: SHERR & VAUGHN, PLLC, 620 HERNDON PARKWAY, SUITE 320, HERNDON, VA, 20170, US

(21) Appl. No.: 12/715,740

(22) Filed: Mar. 2, 2010

(30) Foreign Application Priority Data
Mar. 31, 2009 (KR) 10-2009-0027474

(51) Int. Cl. B66C 17/06; B66C 1/28; B66C 17/04

(52) U.S. Cl. 212/203

(57) ABSTRACT

This invention regards to a ceiling movable disused car scrapping system, more specifically, the invention is capable of to adjust the height and to move left and right hand side by itself at its position, and, as it mounts the disused car, it is capable of adjusting the disused car height and rotating, and adjusting the disused car location. Thus it can scrape the disused car at its position as a one-stop disused car scrapping system.

The invention consisted of a rail transfer unit (10) which includes rail pulley (14) installed at the ceiling rail (11); an up-and-down transfer unit (20), of which extension length was adjusted by a cylinder actuator (24) of a up-and-down cylinder (23) of an up-and-down boom (22), which is installed at inside of a fixed boom (21) that was connected to the rail pulley (14) in a vertical direction; a boom operation unit (50) which includes a movable boom (52), which was installed at inside of a boom (51) connected at the bottom of the up-and-down boom (22), connected by a cylinder actuator of an operation cylinder (53); an upright unit (40), which connects an upright column (41), extended from the movable boom (52), to the top of a stack column (62) and connects a cylinder actuator (44) of an upright cylinder (42) that is connected to the movable boom (52) to a upright reinforcing bar (43); and a disused car fasten unit (60) which includes a stack base (61), installed at bottom of the stack column (62), to support the disused car and a push bar (66) with a push plate (67), which is installed at a push column (65) extended from the stack column (62), connected to a cylinder actuator (64a) of a push cylinder (64).

The present application claims priority under 35 U.S.C. §119 to Korean Patent Application No. 10-2009-0027474 (filed on Mar. 31, 2009), which is hereby incorporated by reference in its entirety.

### BACKGROUND

The invention regards to a ceiling movable disused car scrapping system, more specifically, the invention is capable of to adjust the height and to move left and right hand side by itself at its position, and, as it mounts the disused car, it is capable of adjusting height and rotating, and adjusting the disused car location thus it can scrape the disused car at its position as a one-stop disused car scrapping system.

Automobile ownership increases in every year in Korea and it counts over 1,600 at 2007. Also, domestic demand sales volume was over 1,200,000 at 2007. The amount of the disused car was about 530,000 at 2006, but it increases around 1,000,000 at 2015. Thus, proper dispose of the disused cars is very important and predispose is necessary for recycle or reuse of parts and material. Currently, 75% of the nation's disused cars are recycled as used parts and scrape metals, and rest of 25% is buried as disused car residue. Existing disused car scraping systems are two types of the separation and transfer types. The separation type of disused car dispose system has been used in most of junkyards since the disused car dispose was started. This type has advantage of flexibility of process because each process site is separated and disposes required process by convenience, but it has disadvantage of difficulty of transfer and none secure in mass dispose capability because it use forklift mostly in each movement of process. Also, the separation dispose type could offer a convenience operation environment by moving the disused car to the desired direction and place, but this dispose type is very difficult to move the disused car to a desired direction and the position. Thus, this dispose type is very inconvenient and time consuming due to the operator's inconvenient posture and environment.

The transfer type, which was developed to compensate the disadvantage of the separation type disused car dispose system, disposes the disused car by arranging the disused car using semi automatic equipments and manual operation like an automobile production line. This type has advantage of convenience of transfer because it processes in a consecutive order and disposes mass amount of disused cars. But this type of process requires an extensive site and high initial investments, and lowers the process flexibility.

### SUMMARY

The invention was devised to solve disadvantages in existing disused car scrape systems. Operator could dispose the disused car by switching the position of the disused car freely with loaded state of the disused car at a confined space. The invention allows the disused car to move a desired position while it loaded to the ceiling rail. The disused car can be rotated, changed its position, and moved to an operator's desired position while it loaded. Thus, objective of the invention was that it allows operator to process the dispose operation quickly by allowing the height adjustment, rotation, movement, and transfer direction of the disused car freely.

The invention consisted of a rail transfer unit which includes a rail pulley installed at the ceiling rail; an up-and-down transfer unit, of which extension length can be adjusted by a cylinder actuator of a up-and-down cylinder attached to an up-and-down boom, which was installed at inside of a fixed boom connected to the rail pulley in a vertical direction; a boom operation unit which includes a movable boom, which is installed at inside of a boom connected to the bottom of the up-and-down boom, with a cylinder actuator of an operation cylinder; an upright unit, of which the upright column is connected to the upper stack column that is extended vertically and a cylinder actuator of an upright cylinder is connected to an upright reinforcing bar; and a disused car fasten unit of which a stack base, which was installed at bottom of the stack column, supports the disused car and a push bar with a push plate, which is installed at a push column extended from the stack column and connected to a cylinder actuator of a push cylinder.

The invention devised a disused car scrape system which is capable of position change, height adjustment, and left- and right-hand side movement while the disused car is mounted.

The invention adjusts the height of the disused car in vertical direction using a boom, is capable of forward and backward movement, is capable of adjusting the height and moving in various positions, and rotating the disused car while it is mounted at a desired position using the disused car fasten unit. Thus, operator is allowed moving the disused car to a desired position quickly and conveniently to dispose the disused car.

The invention pushes disused car to the compressor to compress it right after operator separated necessary parts from the disused car.

The invention is capable of being installed at an existing building, outstanding in safety aspect of view during operation, and convenient to move the separated parts to a desired place.

### BRIEF DESCRIPTION OF THE DRAWINGS

FIG. 1 is a front view of a desired example of the invention;

FIG. 2 is a side view of installation state of the invention;

FIG. 3 is a front view of the up-and-down transfer unit and the boom operation unit of the invention;

FIG. 4 is a side view of an installation state of the upright unit of the invention;

FIG. 5 is a plain view of an installation state of the upright unit of the invention;

FIG. 6 is a plain view of an operation state of the disused car fasten unit of the invention;

FIG. 7 is a front view of an installation state of the disused car fasten unit of the invention;

FIG. 8 is a front view of an operation state of the disused car fasten unit of the invention;

FIG. 9 is a front view of an operation state of the upright unit and the disused car fasten unit;

FIG. 10 is a plain view of an installation state of the compress unit.

### DESCRIPTION

Following explains desirable examples of the invention in detail according to figures attached.

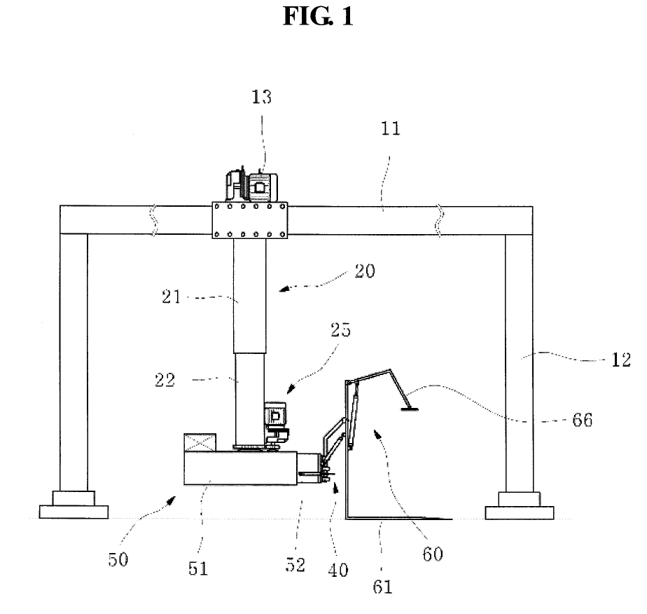

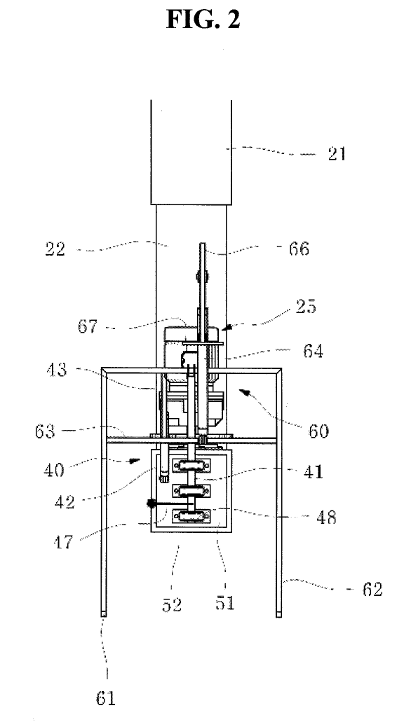

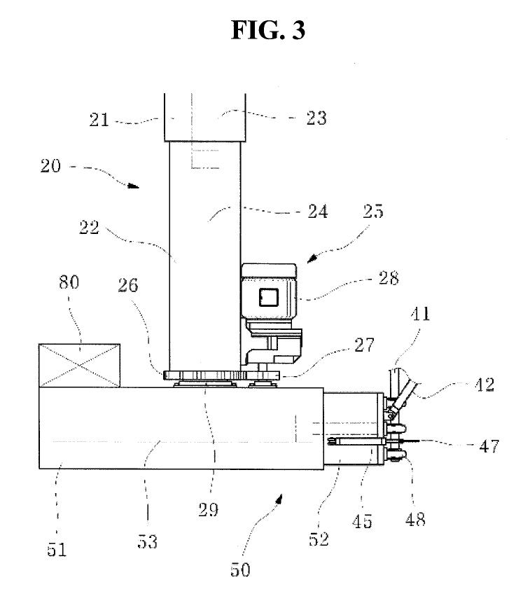

FIG. 1 is the front view of the invention, FIG. 2 is the side view of the invention in an installation state, and FIG. 3 is the front view of the up-and-down transfer unit and the boom operation unit.

Main columns (12) are installed with a certain distance, and the ceiling rail (11) was installed at the top of the main columns. Thus, it is free of move either to left or right hand side by the rail transfer unit (10).

The ceiling rail (11) installed at the top of the main columns (12) moves either to the front or back. The rail transfer unit (10) allows the rail pulley (14) either to move or stop at a desired position by controlling the power of the motor (13).

The fixed boom (21) is extended to a downward direction vertically from the up-and-down transfer unit (13), which is installed at under the rail pulley (14). The up-and-down boom (22) is installed inside of the fixed boom (21) and it was connected to the cylinder actuator (24) of the up-and-down cylinder (23) to move freely either to upward or downward.

The rotation unit (25), which is installed at the bottom of the up-and-down boom (22) installed at the bottom of the up-and-down transfer unit (20), allows 360° rotation of the boom operation unit (50). The rotation unit (25) consisted of a rotation gear (26), a circumscribe gear (27), a motor (28), and a center column (29). The rotation gear (26) contacts with the circumscribe gear (27), and the circumscribe gear (27) was connected to the motor (28) and allows to transfer power. A boom (51), which controls rotation, is connected to the rotation gear (26) through the center column (29).

The rotation unit (25) consisted of the boom operation unit (50) which consisted of the boom (51) and the movable boom (52) installed at inside of the boom (51); the upright unit (40), which is installed at the front of the movable boom (52), rotates the disused car mounted on the stack base (61); the disused car fasten unit (60), installed at the support bar of the stack column (62), which fastens the disused car (90) by moving the push bar (66); and the compressing unit (70) which compresses and fastens the disused car in the compressor after parts of the disused car were eliminated.

The boom operation unit (50) controls the extension length of the movable boom (52) installed at inside of the boom (51) with a hydraulic unit (80) installed at the boom (51). The movable boom was connected to the cylinder actuator (54) of the operation cylinder (53).

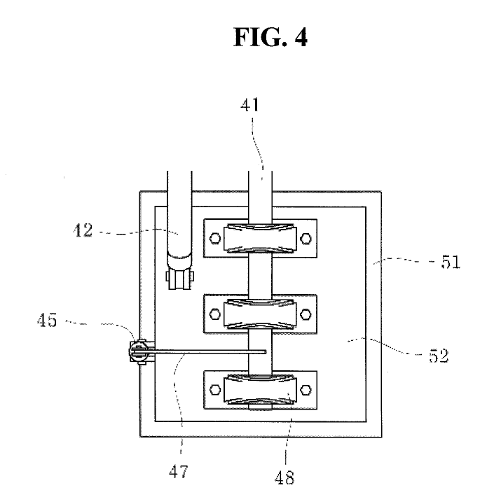

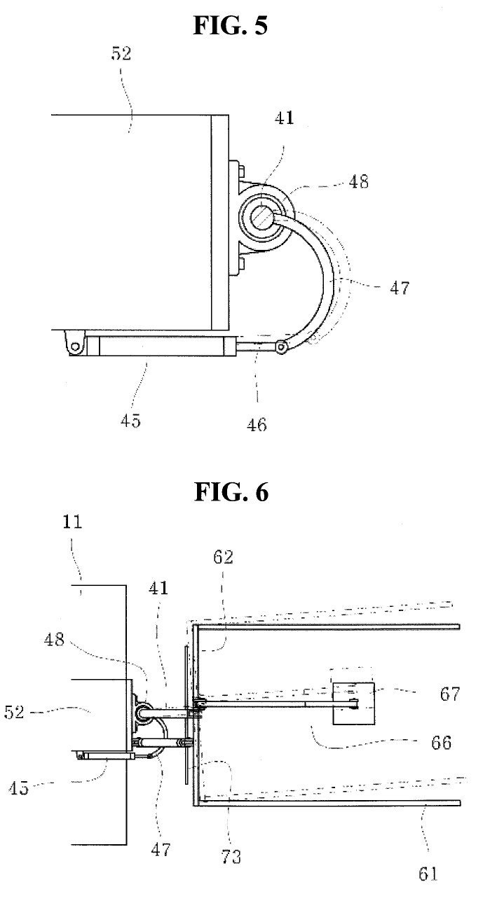

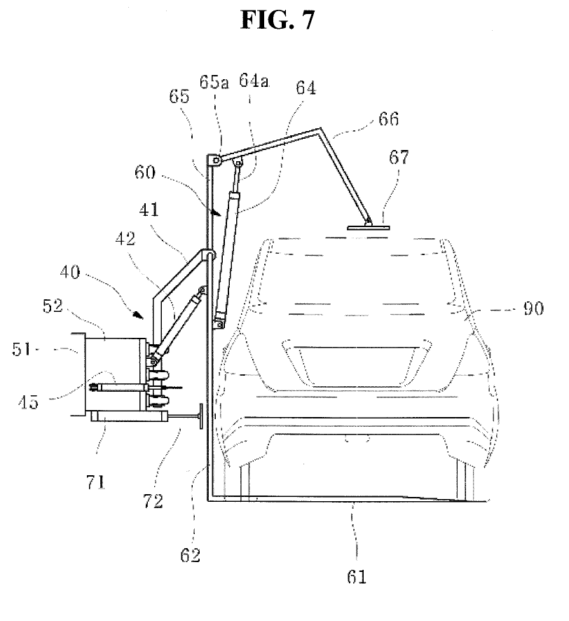

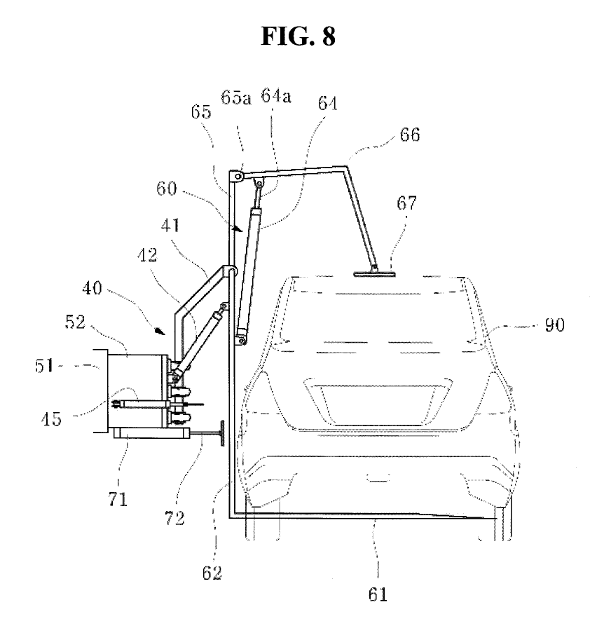

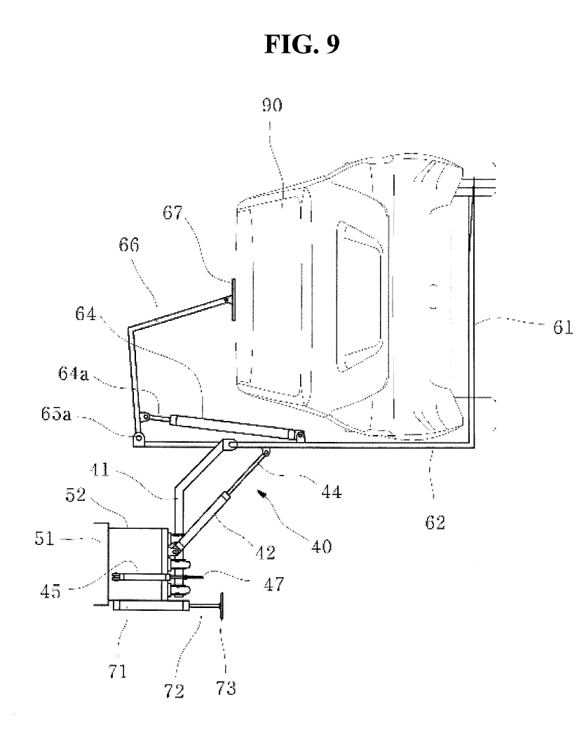

FIGS. 4 and 5 shows a side and a plain view of the upright unit of the invention in an installation state, respectively. FIG. 6 shows a plain view of the disused car fasten unit of the invention in an operation state. FIG. 7 shows a front view of the disused car fasten unit in an installation state. FIG. 8 shows a front view of the disused car fasten unit in an operation state. FIG. 9 shows a front view of the upright unit and the disused car fasten unit in an operation state.

The upright column (41) is installed vertically using a bearing for free of rotation at the front center of the movable boom (52). The upper portion of the upright column (41) is slanted toward to a right-hand side (FIG. 8) and connected to the upper center of the stack column (62) for the upright unit (40) installation.

The upright unit (40) extends the upright cylinder (42) from a portion of the movable boom (52) and connects the upright cylinder (42) to the upright reinforcing bar (43). The upright column (41) is connected to a rotation connecting bar (47), which is connected to a cylinder actuator (46) of a rotation cylinder (45). The rotation cylinder was attached to the movable boom (52).

At the disused car fasten unit (40), located at front of the upright unit (40), two stack bases (61) are installed at both sides to mount the disused car and the stack columns (62) are installed at the two stack bases with a certain height. The support bar (63) is inserted between the two stack columns. The upright reinforcing bar (43) is installed vertically at a portion of the support bar (63).

The push column (65) is installed at the center of the upper stack column (62). At the top of the push column, the push bar (66) is attached to upward as slanted then it is lowered with a hinge (65a). The push plate (67) then is attached to the end of the push bar (66).

The push cylinder (64) is attached to the support bar (63) to connect the cylinder actuator (64a) to the push bar (66).

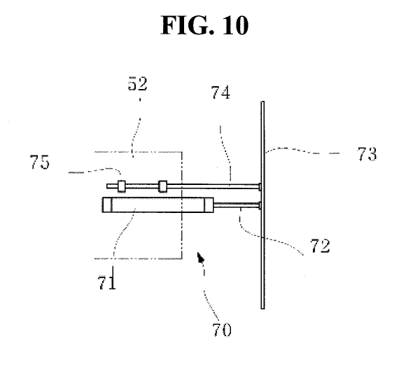

FIG. 10 shows a plain view of the compression unit in an installation state. The compression unit (70) has the compression cylinder (71), which is installed at the lower part of the movable boom (52), such that the cylinder actuator is connected to the compression plate (73). A guide bar (74) is installed at a portion of the compression plate (73) and it is supported by a guide (75).

The invention consisted of units as stated above devised to install the ceiling rail (11) with a desired length between the two main columns (12) such that the ceiling rail (11) can move back and forth freely.

On the ceiling rail (11), the rail transfer unit allows to move left- or right-hand side freely. The rail pulley (14) on the ceiling rail (11) moves freely to a desired direction by the powered motor (13). The up-and-down transfer unit (20) is located under the rail transfer unit such that it supports the load and moves freely.

The rotation unit (25) is attached to the bottom end of the up-and-down transfer unit (20), and it's circumscribe gear (27) is rotated by the motor (28). The rotation gear (26) contacted with the circumscribe gear (27) rotates the boom operation unit (50) 360° to position a desired direction.

The rotation unit (25) moves the disused car fasten unit (60) with the disused car mounted to a desired direction. After move the disused car fasten unit (60) to a direction and position, the up-and-down cylinder installed at inside of the fixed boom (21) of the up-and-down transfer unit (20) moves the boom (51) either up or down to adjust the height. Thus, the height of the disused car (90) can be adjusted freely by the up-and-down transfer unit (20).

The operation cylinder (53) of the boom operation unit including the boom (51) extends the movable boom (52) by the cylinder actuator (54) thus it can adjust the length of the movable boom (20) for a desired position and carryout the process.

The disused car fasten unit (60), located in front of the movable boom (52), fastens the disused car safely by mounting the disused car (90) with the stack base (61), which is located under the vehicle shaft, and pushes the disused car (90) roof by the push plate (67) which is lowered by the push bar (66) connected with the cylinder actuator (64a) by powering the push cylinder (64).

The guide bar (74), installed to a rod of the compression plate (73) and supported by the guide (75), compress the disused car (90) without deformation or jostle of the compression plate (73).

The disused car fasten unit (60) moves the separated parts to a desired place or other transfer operation as well as stacks and transfers the disused car (90).

The invention is capable of fastening the disused car and moving to a desired place or allows operator to separate necessary parts quickly and safely by adjusting the height and the rotation of the disused car within a determined range.

1-5. (canceled)

6. A disused car scrapping system comprising:
a rail transfer unit including a rail pulley installed at a ceiling rail;
an up-and-down transfer unit which adjusts extension height of an up-and-down boom, by a first cylinder actuator of an up-and-down cylinder, wherein the up-and-down boom is installed at least partially inside a fixed boom;
a boom operation unit which connects a movable boom to a second cylinder actuator of a operation cylinder, wherein the movable boom is installed inside a fourth boom which is attached to the up-and-down boom;
an upright unit which connects a third cylinder actuator of an upright cylinder, which is connected to the movable boom, to the upright reinforcing bar and an upright column extended from the movable boom connected to an upper stack column; and
a disused car fasten unit which supports a disused car by installing a stack base at a bottom end of the stack column and pushes the disused car by installing a push plate located at an end of a push bar extended from a push column that is extended from the stack column.

7. The disused car scrapping system of claim 6, further including:
a rotation unit which rotates the fourth boom by a center column that is rotated by a rotation gear which engages a circumscribe gear, wherein the rotation unit is powered by a motor at the bottom of the up-and-down boom.

8. The disused car scrapping system of claim 6, wherein the upright column is connected to the stack column at the top of the upright unit, and the upright column is capable of rotating by installing a bearing, and the upright reinforcing bar connected to the cylinder actuator of the upright cylinder that is connected to the movable boom rotates the disused car 90°.

9. The disused car scrapping system of claim 6, wherein the disused car fasten unit includes a support bar connected to both sides of the stack column, a fourth cylinder actuator of a push cylinder which is connected to the support bar, and wherein the push bar is connected with a hinge to a push column that is extended from the stack column.

10. The disused car scrapping system of claim 6, further including a compress unit in which a push plate is connected to a fifth cylinder actuator of a compress cylinder at the movable boom, and a guide bar connected to the push plate supports a guide.
